(19) United States
(12) Patent Application Publication
(10) Pub. No.: US 2018/0267671 A1
(43) Pub. Date: Sep. 20, 2018

(54) TOUCH SCREEN SYSTEM AND METHOD FOR DRIVING THE SAME

(71) Applicant: Edito Co., Ltd., Seoul (KR)

(72) Inventors: Junhee LEE, Seoul (KR); Hakcheol LEE, Seoul (KR)

(21) Appl. No.: 15/460,204

(22) Filed: Mar. 15, 2017

(51) Int. Cl. G06F 3/042; G06F 3/041

(52) U.S. Cl. CPC G06F 3/0421; G06F 3/0416; G06F 2203/04108; G06F 3/0425; G06F 2203/04105; G06F 3/0428

(57) ABSTRACT

A touch screen system may include a display; a first optical emitter disposed in association with a first side of the display, the first optical emitter being configured to emit a first infrared (IR) ray beam in a first direction; a first optical receiver disposed in association with a second side of the display, the first optical receiver being configured to receive the first IR ray beam; and a controller configured to determine, in response to obstruction of the first IR ray beam by a portion of an object, an interactive state of the object with the display based on an amount of cross-sectional area of the first IR ray beam obstructed by the portion. A height of the first IR ray beam in a second direction is greater than a width of the first IR ray beam in a third direction.

### BACKGROUND

### Field

One or more exemplary embodiments relate to touch detection, and more specifically, to an infrared (IR) type touch screen system and a method for driving the same.

### Discussion

In general, a touch screen is a device that forms an interface between users and a device, such as a telecommunication device having a display device. A user may touch a screen of the touch screen using a stylus pen or an appendage (e.g., a finger) to interface with the telecommunication device.

Touch screens may be categorized into various types, such as a resistive type, a capacitive type, an acoustic (e.g., ultrasonic wave) type and an infrared (IR) type, based on a touch recognition process.

With respect to conventional IR type touch screens, the linearity of an IR ray's trajectory is utilized. When an IR ray is cut, it may be assumed that it has met obstacle. A contact point from the user's touch may cut off IR rays emitted along horizontal and vertical directions, and X and Y coordinates of points where the IR rays are cut off may be sensed. In this manner, the IR type touch screen identifies a touch point by determining the positions of blocked IR ray beams. To form an invisible IR matrix, an IR ray beam is emitted from a determined surface of each of X and Y axis, and the emitted IR ray beam is received by an opposite surface in the IR type touch screen.

Conventional IR type touch screens are relatively easy to install and relatively low pressure may be used for interaction. Conventional IR type touch screens typically cannot detect other types of inputs (e.g., hover).

A need, therefore, exists for efficient, cost effective techniques enabling IR touch screens to detect other forms of input such as hovering interaction.

The above information disclosed in this Background section is only for enhancement of understanding of the background of the inventive concept, and, therefore, it may contain information that does not form the prior art that is already known in this country to a person of ordinary skill in the art.

### SUMMARY

One or more exemplary embodiments provide an infrared (IR) type touch screen system and a method for driving the same.

Additional aspects will be set forth in the detailed description which follows, and, in part, will be apparent from the disclosure, or may be learned by practice of the inventive concept.

According to one or more exemplary embodiments, a touch screen system may include a display; a first optical emitter disposed in association with a first side of the display, the first optical emitter being configured to emit a first infrared (IR) ray beam in a first direction; a first optical receiver disposed in association with a second side of the display, the first optical receiver being configured to receive the first IR ray beam; and a controller configured to determine, in response to obstruction of the first IR ray beam by a portion of an object, an interactive state of the object with the display based on an amount of cross-sectional area of the first IR ray beam obstructed by the portion. A height of the first IR ray beam in a second direction is greater than a width of the first IR ray beam in a third direction.

According to one or more exemplary embodiments, a method for driving a touch screen system, the method may include emitting, in association with a display, a first infrared (IR) ray in a first direction; determining, in response to receiving a portion of the first IR ray, an amount of cross-sectional area of the first IR ray obstructed by an object; and determining, based on the amount, an interactive state of the object with the display.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a schematic plan view of an optical type touch screen system according to one or more exemplary embodiments.

FIG. 2A is a schematic plan view of an optical type touch screen system according to one or more exemplary embodiments.

FIG. 2B is a front view of the optical emitter of FIG. 2A according to one or more exemplary embodiments.

FIG. 2C is a perspective view of a part of the optical emitter of FIG. 2B according to one or more exemplary embodiments.

FIG. 3 is a schematic plan view of an IR type touch screen system according to one or more exemplary embodiments.

FIG. 4 is a cross-sectional view of the touch screen system of FIG. 3 according to one or more exemplary embodiments.

FIG. 5 is an enlarged view of area A in FIG. 4 according to one or more exemplary embodiments.

FIG. 6 is a cross-sectional view illustrating a first threshold and a second threshold of an IR ray beam according to one or more exemplary embodiments.

FIG. 7 is a cross-sectional view illustrating various touch detection states in accordance with a degree of a blocked area of an IR ray beam according to one or more exemplary embodiments.

FIG. 8 is a flow chart illustrating a method of driving touch screen system according to one or more exemplary embodiments.

FIG. 9 is a schematic plan view of an IR type touch screen system according to one or more exemplary embodiments.

FIG. 10 is a cross-sectional view illustrating various touch detection states in accordance with a degree of a blocked area of IR ray beam and pressure detection according to one or more exemplary embodiments.

FIG. 11 is a flow chart illustrating a method of driving touch screen system according to one or more exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

For instance, one or more exemplary embodiments may be described and/or illustrated in terms of functional blocks, units, and/or modules. One of ordinary skill in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar devices, the blocks, units, and/or modules may be programmed using software (e.g., microcode) to perform various features, functions, and/or processes discussed herein, and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, without departing from the scope of the inventive concepts, a block, unit, and/or module may be physically separated into two or more interacting and discrete blocks, units, and/or modules or may be physically combined into more complex blocks, units, and/or modules.

Unless otherwise specified, the illustrated exemplary embodiments are to be understood as providing exemplary features of varying detail of various exemplary embodiments. Therefore, unless otherwise specified, the features, components, modules, layers, films, panels, regions, and/or aspects of the various illustrations may be otherwise combined, separated, interchanged, and/or rearranged without departing from the disclosed exemplary embodiments. Further, in the accompanying figures, the size and relative sizes of layers, films, panels, regions, etc., may be exaggerated for clarity and descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. Further, the D1-axis, the D2-axis, and the D3-axis are not limited to three axes of a rectangular coordinate system, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing various exemplary embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used herein, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. In this manner, regions illustrated in the drawings are schematic in nature and shapes of these regions may not illustrate the actual shapes of regions of a device, and, as such, are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

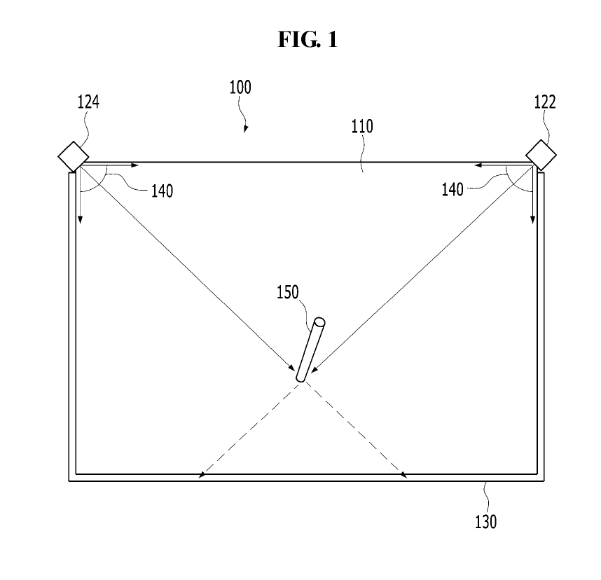

FIG. 1 is a schematic plan view of an optical type touch screen system according to one or more exemplary embodiments.

Referring to FIG. 1, an optical type touch screen system 100 may include a pair of optical units 122, 124 in corners (e.g., adjacent corners) an input area (e.g., display panel) 110 and a retro-reflective layer 130 along a plurality (e.g., three) of three edges of the input area 110. To one or more exemplary embodiments the input area may be rectangular shaped, but exemplary embodiments are not limited thereto. Each of optical units 122, 124 may include a light source (e.g., an optical emitter) emitting a plurality of IR ray beams 140 across the input area 110, and a photo-detector array (e.g. a line camera) including detector pixels to receive light (IR ray beams) retro-reflected from a portion of the retro-reflective layer 130. A touch object 150, such as finger or stylus pen, in the input area 110 may block at least some of the retro-reflected light reaching one or more of the detector pixels in each photo-detector array. In this manner, a position may be determined by triangulation. That is, according to the optical type touch screen system 100, a touch event may be detected by the shadowing of two paths in a sheet of light (IR ray beam) established in front of the input area 110.

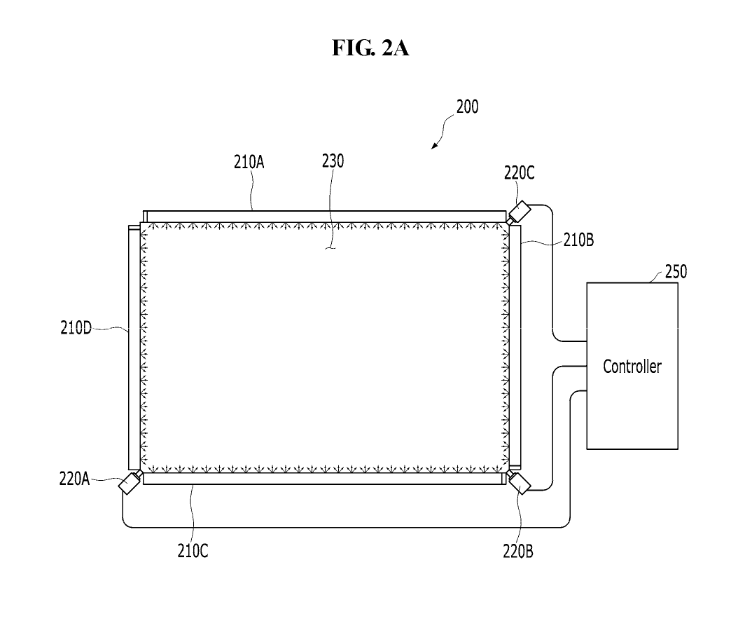

FIG. 2A is a schematic plan view of an optical type touch screen system according to one or more exemplary embodiments. FIG. 2B is a front view of the optical emitter of FIG. 2A according to one or more exemplary embodiments. FIG. 2C is a perspective view of a part of the optical emitter of FIG. 2B according to one or more exemplary embodiments.

Referring to FIG. 2A, an optical type touch screen system 200 may include optical emitters 210A, 210B, 210C, and 210D , IR cameras 220A, 220B, and 220C, and a controller 250. The optical emitters 210A, 210B, 210C, and 210D may enclose edges of an input area (e.g., display panel) 230. Also the optical emitters generate a plurality of IR ray beams and may be disposed on the four sides of the input area (e.g., display panel) 230.

Each of the IR cameras 220A, 220B, and 220C, which are cameras that are sensitive to IR ray beam, may include a lens and an image sensor. The lens may have a field of view of 90 degrees or more. The image sensor may be a charge-coupled device (CCD) image sensor or a complementary metal-oxide semiconductor (CMOS) image sensor.

The IR cameras 220A, 220B, and 220C may detect locations of the IR ray beams blocked by a touch object being touched in the input area (touch area) 230, and provide the controller 250 with the detected data. Then, the controller 250 calculates location coordinates of the touch object being touched in the touch area 230 based on the data detected by the IR cameras 220A, 220B, and 220C.

As shown in FIGS. 2B and 2C, each of the optical emitters 210A, 210B, 210C, and 210D may include at least one IR LED 211 and a light distributor 212. The light distributor 212 distributes IR light from the IR LED 211 to a plurality of IR ray beams at a predefined spacing.

For example, the light distributor 212 may include a transparent rod 213 and a diffuser 214. The transparent rod 213 may be made of a transparent plastic or glass substance, and may have a rectangular cross-section. The IR LED 211 may be disposed on at least one end of the transparent rod 213 as shown in FIG. 2B.

The transparent rod 213 may have grooves 223a on one side at predetermined space intervals along the length thereof. The light from the IR LED 211 that passes into one end of the transparent rod 213 is diffuse reflected by the grooves 223a, thereby generating the IR ray beams at a predetermined spacing can be generated from the transparent rod 213.

The diffuser 214 may be provided to enable the IR ray beams to emit from the grooves 223a evenly in all directions. The diffuser 214 may be a diffusion film. The diffusion film may have a diffuse reflection surface, and be attached on a portion of the transparent rod 213 where the grooves 223a are formed.

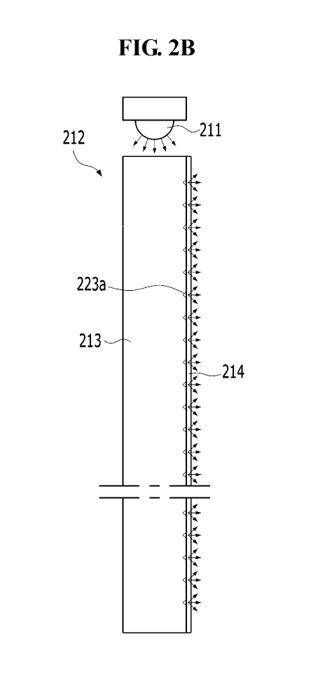

FIG. 3 is a schematic plan view of an IR type touch screen system according to one or more exemplary embodiments.

Referring to FIG. 3, an IR type touch screen system 300 may include arrays of discrete light sources (e.g., LEDs) 312, 322 along sides (e.g. two adjacent sides) of an input area (e.g., display panel) 230 emitting sets (e.g., two sets) of parallel beams of light B1, B2 towards opposing arrays of photo-detectors (e.g., beam detector) 312′, 322′ along the other sides (e.g. opposite two adjacent sides) of the input area. To one or more exemplary embodiments the input area may be rectangular shaped, but exemplary embodiments are not limited thereto.

For instance, the IR type touch screen system 300 may include display panel 230, optical emitters 310, 320 emitting an IR ray beams B1, B2 at a side of the display panel 230, optical receivers 310′, 320′ receiving the IR ray beams B1, B2 from the optical emitters 310, 320 at opposite sides of the display panel 230, and a controller 350 configured to determine a touching or hovering position of a touch object 150, such as finger or stylus pen, in accordance with a degree of a blocking area of the IR ray beam B1′, B2′ by the touch object 150.

Here, the height of the IR ray beams B1, B2 in a third direction D3 may be greater than the width of the IR ray beam B1 in a second direction D2 or the width of the IR ray beam B2 in a first direction D1 in order to accurate detect the a degree of a blocking area of the IR ray beam B1′, B2′ by the touch object 150.

The display panel 230 may be a display device such as TV, projection monitor, and display board. For example, the display panel 230 may include a liquid crystal display device (LCD), an organic light emitting display device (OLED), Quantum dot display (QD) device, etc.

The optical emitters 310, 320 may include a first optical emitter 310 emitting the IR ray beams B1 in a first direction D1 and a second optical emitter 320 emitting the IR ray beam B2 in the second direction D2. Further, the first optical emitter 310 may include a plurality of first LEDs (first LED 1˜first LED n) 312 emitting the IR ray beams B1 in the first direction D1, and the second optical emitter 320 includes a plurality of second LEDs (second LED 1˜second LED n) 322 emitting the IR ray beams B2 in the second direction D2.

Also, the optical receivers 310′ 320′ may include a first optical receiver 310′ including a plurality of first IR ray beam detectors (first detector 1˜first detector n) 312′ detecting the IR ray beams B1 from the first LEDs 312, and a second optical receiver 320′ including a plurality of second IR ray beam detectors (second detector 1˜second detector n) 322′ detecting the IR ray beams B2 from the second LEDs 322.

The ‘optical’ and ‘infrared’ type touch screen systems shown in FIGS. 1 to 3, may detect a touch event based on the shadowing of two light paths.

For example, if the touch object 150 blocks the IR ray beam B1, B2, X and Y coordinates of the point where the IR ray beams B1′, B2′ blocked by the touch object 150 are detected by the first and second IR ray beam detectors 312′, 322′.

The controller 350 may communicate with the optical emitters 310, 320 and the optical receivers 310′, 320′ in order to determine an interaction position of the touch object 150 in accordance with a degree of a blocking area of the IR ray beams B1′, B2′ by the touch object 150. For instance, if the touch object 150 in the input area (display panel) 230 blocks a determined portion of at least one beam in each of the two axes as direct contacting the display panel 230 by the touch object 150, its location can be readily determined. Here, the controller 350 may determine the touch object 150 is in a touch state.

The controller may be implemented as electronic hardware, computer software, or combinations of both. In order to describe the interchangeability of hardware and software, various illustrative features, blocks, modules, circuits, and steps have been described above in terms of their general functionality. Whether such functionality is implemented as hardware or software depends upon the particular application and design constraints for the overall system. A person of ordinary skill in the art may implement the functionality in various ways for each particular application without departing from the scope of the present invention.

The hardware used to implement the various illustrative logics, logical blocks, modules, and circuits described in connection with the exemplary embodiments disclosed herein may be implemented or performed with a general purpose processor, a digital signal processor (DSP) an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory processor-readable storage medium or a non-transitory computer-readable storage medium. lion-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data. structures and that may be accessed by a computer. Disc includes optically reproducible data such as a compact disc (CD), laser disc, optical disc, digital versatile disc (MD), and blu-ray disc. Disk includes magnetically reproducible data such as a floppy disk. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

Moreover, the controller 350 may be able to determine a hovering position of the touch object 150 in accordance with a degree of a blocking area of the IR ray beam B1′, B2′ by the touch object 150. For instance, if the touch object 150 in the display panel 230 blocks some portion (less than the level of the determined portion) of at least one beam in each of the two axes, its pointing location can also be determined. That is, when the touch object 150 indicates a position on the display panel 230 without contacting the display panel 230, the position on the display panel 230 can be determined. In this manner, the controller 350 may determine the touch object 150 is in a hover state.

In other words, the ‘touch’ by the touch object 150 may include a non-contact touch (or almost contacts) (e.g., hovering interactions), not limited to contacts between the display panel 230 and the user's body part (e.g., finger) or the touch input tool (e.g., stylus pen). A hover state corresponds to the non-contact touch. When the touch object 150 is in a hover state, the controller 350 may recognize the coordinates of the touch object 150, so that the cursor may be displayed at a position corresponding to the coordinates of the touch object 150 in the hover state.

In one or more embodiments, the touching or hovering position of a touch object 150 may be determined in accordance with a degree of a blocking area of the IR ray beam by the touch object 150. As such, the height of the IR ray beam B1, B2 may be greater than the width of the IR ray beam B1, B2.

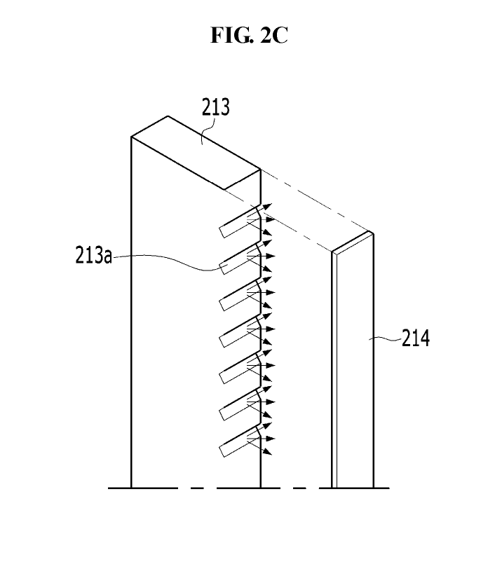

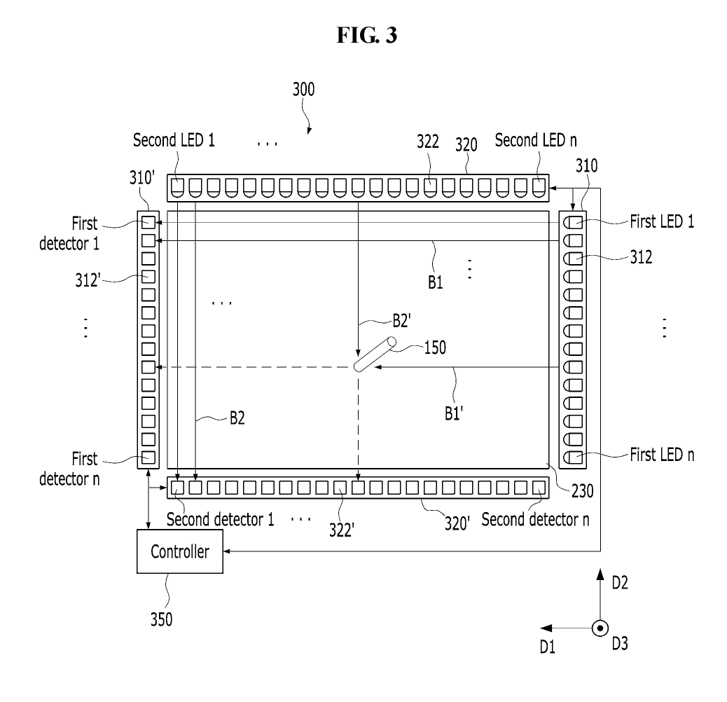

FIG. 4 is a cross-sectional view of the touch screen system of FIG. 3 according to one or more exemplary embodiments. FIG. 5 is an enlarged view of area A in FIG. 4 according to one or more exemplary embodiments.

Referring to FIG. 4 and FIG. 5, the plurality of IR ray beams B1 extend in the first direction D1 and the plurality of IR ray beams B2 extend in the second direction D2 may be arranged in a matrix formation. Also, the cross-sectional view of the plurality of IR ray beams B1 may be substantially identical to the cross-sectional view of the plurality of IR ray beams B2. To this end, the first LEDs 312 and the second LEDs 322 may have the same structure. In one or more exemplary embodiments, the plurality of IR ray beams B1, B2 (B) on the display panel 230 may be spaced apart by the same pitch, respectively.

As seen in FIG. 4, the IR ray beams may have an oval shape. However, the exemplary embodiments are not necessarily limited thereto, and therefore, the IR ray beams according to the exemplary embodiments may include various types of cross-sectional shapes.

Referring to FIG. 4, the plurality of IR ray beams B spaced apart by pitch p.

In one or more exemplary embodiments, for instance, the height h of the IR ray beam B may be greater than the width w of the IR ray beam B. The height h of the IR ray beam B may be less than three times the width w of the IR ray beam B. According to this structure of the IR ray beams, the controller 350 may be able to determine a touching or hovering position of a touch object in accordance with a degree of a blocking area of at least one IR ray beam B1 and at least one IR ray beam B2 by the touch object 150 more accurately.

Moreover, an end (e.g., front end) of the touch object 150 is broader than the pitch p of the adjacent IR ray beams B. That is, the thickness t of the tip point of the touch object 150 is broader than the pitch p of the IR ray beams B. Thus, when the touch object 150 approaches within the height h of the IR ray beam B, the controller 350 should be able to determine whether the touch object 150 is in a hover state or a touch state.

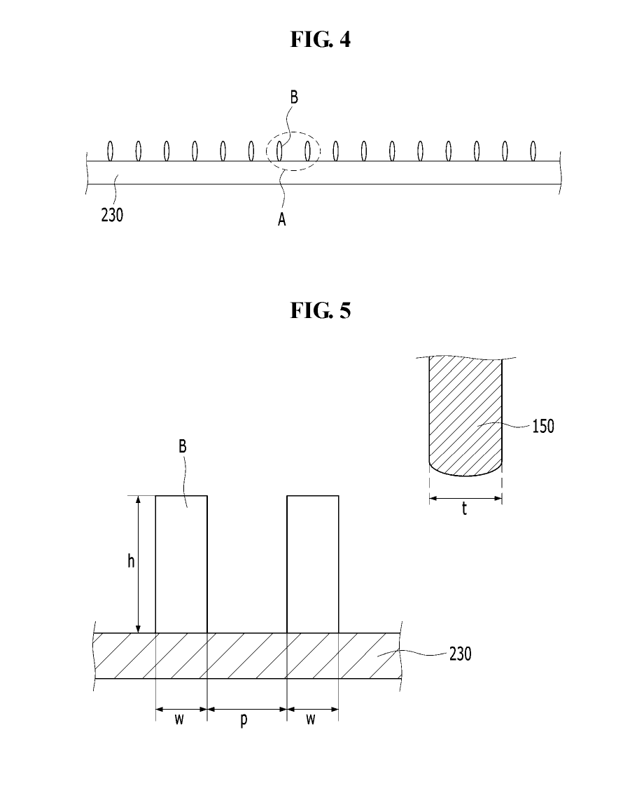

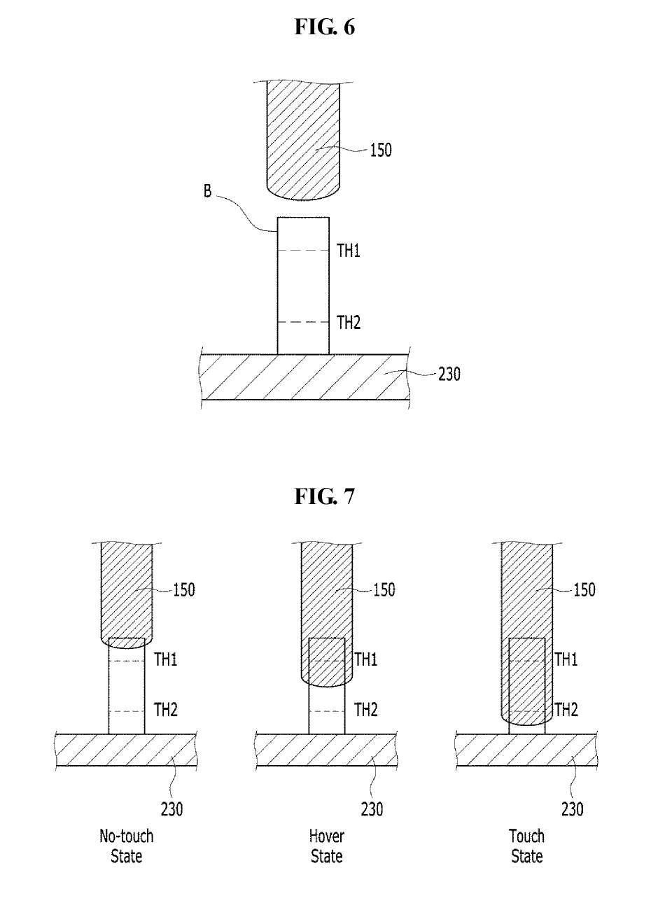

FIG. 6 is a cross-sectional view illustrating a first threshold and a second threshold of an IR ray beam according to one or more exemplary embodiments. FIG. 7 is a cross-sectional view illustrating various touch detection states in accordance with a degree of a blocked area of an IR ray beam according to one or more exemplary embodiments.

For convenience, only one IR ray beam B blocked by the touch object 150 is illustrated in FIG. 6 and FIG. 7, but the touch object 150 may be able to block one or more IR ray beams in a touch or hover state of touch objet 150.

Referring to FIG. 6, the IR ray beam B may include three portions separated by two thresholds TH1, TH2. In this manner, a threshold may be a reference value which determines the state of the touch object 150. The thresholds may correspond to a blocking area of the IR ray beam B by the touch object 150.

For instance, the first threshold TH1 may be a reference value which determines whether the touch object 150 is in a no-touch state or in the hover state. Further, the second threshold TH2 may be a reference value which determines whether the touch object 150 is in the hover state or in the touch state.

According to one or more exemplary embodiments, the first threshold TH1 may correspond to 20% of the cross-sectional area of the IR ray beam B. Further, the second threshold TH2 may correspond to 70% of the cross-sectional area of the IR ray beam B or 80% of the cross-sectional area of the IR ray beam B.

Therefore, if the blocking area of the IR ray beam by the touch object 150 is less than the first threshold TH1, the controller 350 may determine the touch object 150 is in the no-touch state illustrated in FIG. 7.

When the touch object 150 is in the no-touch state, the IR ray beam detector 312′, 322′ for detecting the IR ray beam may detect substantially the cross-sectional area of IR ray beam. The controller 350 may receive this information from the optical receiver 310′, 320′ including the the IR ray beam detector 312′, 322′. Thus, the controller 350 may determine the touch object 150 is in the no-touch state.

If the blocking area of the IR ray beam by the touch object 150 is between the first threshold TH1 and a second threshold TH2, the controller 350 may determine the touch object 150 is in the hover state as illustrated in FIG. 7.

When the touch object 150 is in the hover state, the IR ray beam detector 312′, 322′ for detecting the IR ray beam may detect about 20% to 70% (or 80%) of the cross-sectional area of the IR ray beam being blocked. The controller 350 may receive this information from the optical receiver 310′, 320′ including the the IR ray beam detector 312′, 322′. Thus, the controller 350 may determine the touch object 150 is in the hover state.

As previously described, the hover state corresponds to the non-contact touch (or almost contacts) (e.g., hovering interactions). For example, when the touch object 150 is in a hover state, the controller 350 may recognize the coordinates of the touch object 150, so that a cursor as in a hovering input effect may be displayed at a position corresponding to the coordinates of the touch object 150 in the hover state.

In another example, various hovering input effects corresponding to the hover state may be displayed via the display panel 230. The hovering input effect corresponding to the hover state may be preset.

In addition, if the blocking area of the IR ray beam by the touch object 150 is greater than the second threshold TH2, the controller 350 may determine the touch object 150 is in the touch state as illustrated in FIG. 7.

When the touch object 150 is in the touch state, the IR ray beam detector 312′, 322′ for detecting the IR ray beam may detect over 70% (or 80%) of the cross-sectional area of the IR ray beam. The controller 350 may receive this information from the optical receiver 310′, 320′ including the the IR ray beam detector 312′, 322′. Thus, the controller 350 may determine the touch object 150 is in the touch state.

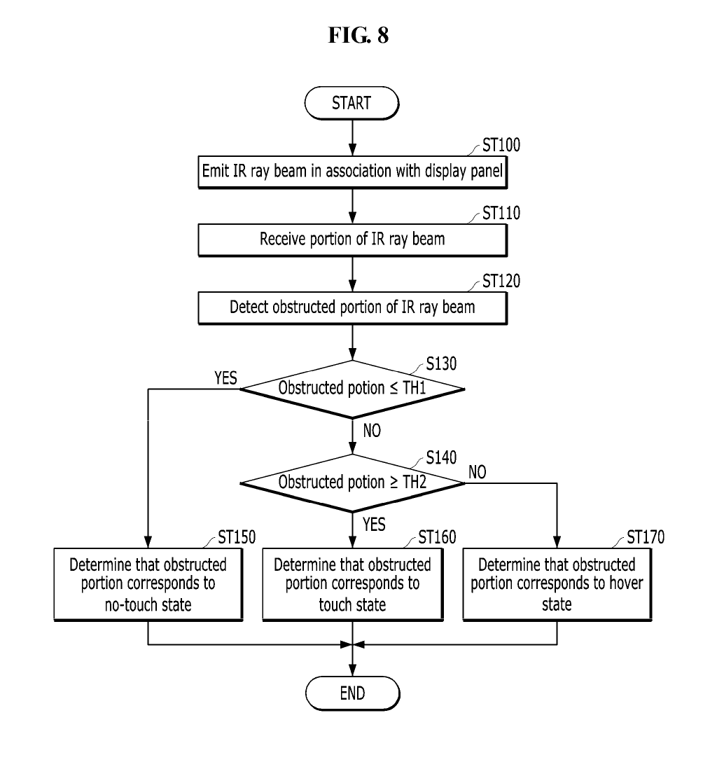

FIG. 8 is a flow chart illustrating a method of driving touch screen system according to one or more exemplary embodiments.

The touch screen system according to one or more exemplary embodiments may include the display panel 230, the optical emitter 310, 320 emitting the IR ray beam at a side of the display panel, the optical receiver 310′, 320′ receiving the IR ray beam from the optical emitter at the opposite side of the display panel, and the controller 350 configured to determine a touching or hovering position of a touch object in accordance with a degree of a blocking area of the IR ray beam by the touch object 150. The height of the IR ray beams B1, B2 in a third direction D3 may be greater than the width of the IR ray beam B1 in a second direction D2 or the width of the IR ray beam B2 in a first direction D1. The detailed descriptions of the touch screen system have already been described in detail with reference to FIGS. 3 to 7. Therefore, duplicative description will be omitted to avoid obscuring exemplary embodiments.

First, referring to FIGS. 3 and 8, Optical emitters 310, 320 may emit IR ray beams B1, B2 in association with the display panel 230 (ST 100). For example, the optical emitters 310, 320 may include a first optical emitter 310 emitting the IR ray beams B1 in a first direction D1 and a second optical emitter 320 emitting the IR ray beam B2 in the second direction D2. Further, the first optical emitter 310 may include a plurality of first LEDs 312 emitting the IR ray beams B1 in the first direction D1, and the second optical emitter 320 includes a plurality of second LEDs 322 emitting the IR ray beams B2 in the second direction D2.

Also, optical receivers 310′, 320′ may receive the IR ray beams B1, B2 from the optical emitters 310, 320 at the opposite side of the display panel 230 (ST 110). Here, the optical receiver 310′, 320′ may include a first optical receiver 310′ having a plurality of first IR ray beam detectors 312′ detecting the IR ray beams B1 from the first LEDs 312, and a second optical receiver 320′ having a plurality of second IR ray beam detectors 322′ detecting the IR ray beams B2 from the second LEDs 322.

When the touch object 150 blocks the IR ray beam B1, B2, X and Y coordinates of the point where the IR ray beams B1′, B2′ blocked by the touch object 150 are detected by the first and second IR ray beam detectors 312′, 322. As such, the controller 350 may communicate with the optical emitter 310, 320 and the optical receiver 310′, 320′, so that the controller 350 may determine a touching or a hovering or no-touching position of the touch object 150 in accordance with a degree of a blocking area of the IR ray beam B1′, B2′ by the touch object 150 (ST 120).

According to one or more exemplary embodiments, the ‘touch’ by the touch object 150 may include a non-contact touch (or almost contacts) (e.g., hovering interactions), not limited to contacts between the display panel 230 and the user's body part (e.g., finger) or the touch input tool (e.g., stylus pen). Therefore, the hover state corresponds to the non-contact touch.

In order to determine the touching or hovering position of a touch object 150 in accordance with a degree of a blocking area of the IR ray beam by the touch object 150, the height of the IR ray beam B1, B2 is greater than the width of the IR ray beam B1, B2.

Referring to FIG. 6, the IR ray beam B may include three portions separated by two thresholds TH1, TH2. In this manner, a threshold may be a reference value which determines the state of the touch object 150. The threshold may correspond to a blocking area of the IR ray beam B by the touch object 150. For instance, the first threshold TH1 may be a reference value which determines whether the touch object 150 is in a no-touch state or in the hover state. Further, the second threshold TH2 may be a reference value which determines whether the touch object 150 is in the hover state or in the touch state.

According to one or more exemplary embodiments, the first threshold TH1 may correspond to 20% of the cross-sectional area of the IR ray beam B. Further, the second threshold TH2 may correspond to 70% of the cross-sectional area of the IR ray beam B or 80% of the cross-sectional area of the IR ray beam B.

Thereafter, if the touch object 150 approaches to the display panel 230, the controller 350 may determine the a degree of a blocking area of the IR ray beam by the touch object 150.

Thus, if the blocking area of the IR ray beam by the touch object 150 is less than or equal to a first threshold TH1, that is, obstructed portion of the IR ray beam by the touch object 150 is less than the first threshold TH1 (S 130), the controller 350 may determine the touch object 150 is in the no-touch state (ST 150).

In other words, when the blocking area of the IR ray beam by the touch object 150 is less than or equal to the first threshold TH1 (S 130), the IR ray beam detector 312′, 322′ for detecting the IR ray beam may detect nearly all areas of IR ray beam. Accordingly, the controller 350 may be able to receive this information from the optical receiver 310′, 320′ including the the IR ray beam detector 312′, 322′. Thus, the controller 350 may determine the touch object 150 is in the no-touch state (ST 150).

In addition, if the blocking area is more than the first threshold TH1, that is, the obstructed portion of the IR ray beam by the touch object 150 is more than the first threshold TH1 (S 130) and less than the second threshold TH2 (S 140), the controller 250 may determine the touch object 150 is in the hover state (ST 170).

In other words, when the blocking area is between the first threshold TH1 and a second threshold TH2 (S 130, S 140), the IR ray beam detector 312′, 322′ for detecting the IR ray beam may detect about 20% to 70% (or 80%) of the cross-sectional area of the IR ray beam. The controller 350 may be able to receive this information from the optical receiver 310′, 320′ including the the IR ray beam detector 312′, 322′. Thus, the controller 350 may determine the touch object 150 is in the hover state (ST 170).

Moreover, if the blocking area of the IR ray beam by the touch object 150 is greater than the second threshold TH2 (S 140), the controller 350 may determine the touch object 150 is in the touch state (ST 160).

In other words, when the blocking area is more than the second threshold TH2 (S 140), the IR ray beam detector 312′, 322′ for detecting the IR ray beam may detect over 70% (or 80%) of the cross-sectional area of the IR ray beam. The controller 250 may be able to receive this information from the optical receiver 310′, 320′ including the the IR ray beam detector 312′, 322′. Thus, the controller 350 may determine the touch object 150 is in the touch state (ST 160).

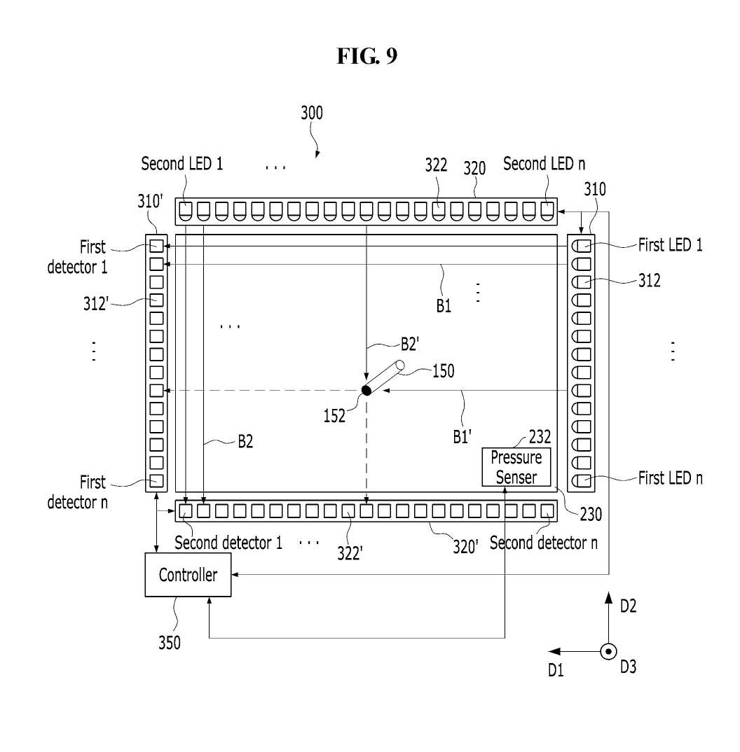

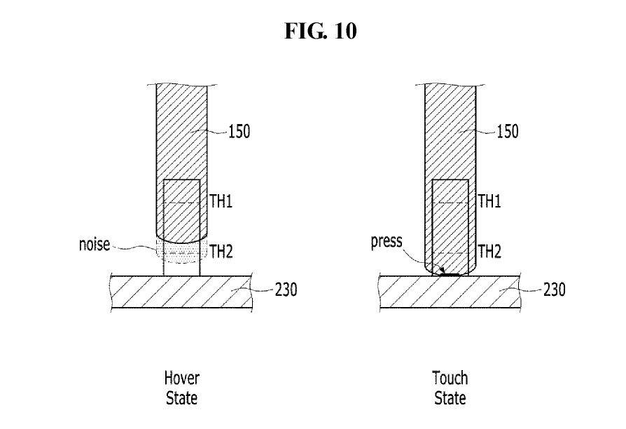

FIG. 9 is a schematic plan view of an IR type touch screen system according to one or more exemplary embodiments. FIG. 10 is a cross-sectional view illustrating various touch detection states in accordance with a degree of a blocked area of IR ray beam and pressure detection according to one or more exemplary embodiments.

In this exemplary embodiment, components identical to those of the aforementioned embodiment illustrated in FIGS. 3 and 7 are designated by like reference numerals, and their detailed descriptions are not repeated to avoid redundancy and for easy description.

Referring to FIG. 9, an IR type touch screen system 300 according to one or more exemplary embodiments may further include a pressure sensor 232 in the display panel 230 or a pressure sensor 152 in the touch object 150.

The pressure sensor 232 may be a piezo film on the surface of the display panel 230. The piezo film may be able to detect whether the touch object 150 contacts the surface of the display panel 230 or not. In other words, when the touch object 150 actually contacts the surface of the display panel 230, the variance of the pressure can be detected by the pressure sensor 232. Then, the information with respect to the detection of the pressure may be transmitted to the controller 350 by communicating between the controller 350 and the pressure sensor 232.

In addition, other types of the pressure sensor 152 such as a strain gage may be implemented to the touch object 150 as well. The pressure sensor 152 may be formed on the end portion of the touch object 150 as shown in FIG. 9. In this case, the touch object 150 may be the active or passive type stylus pen.

The pressure sensor 152 also can detect whether the touch object (i.e., stylus pen) 150 contacts the surface of the display panel 230 or not. In other words, when the touch object 150 actually contacts the surface of the display panel 230, the variance of the pressure can be detected by the pressure sensor 152. Then, the information with respect to the detection of the pressure may be transmitted to the controller 350 by wireless communicating (e.g., Bluetooth communication) between the controller 350 and the pressure sensor 152. Thus, the hover state and the touch state can be more clearly distinguished according to this exemplary embodiment.

In determining the hover state according to this exemplary embodiment, if the blocking area of the IR ray beam by the touch object 150 is between the first threshold TH1 and a second threshold TH2, the controller 350 may determine the touch object 150 is in the hover state same as the exemplary embodiment illustrated in FIGS. 3 and 7.

However, as shown in FIG. 10, if the blocking area of the IR ray beam by the touch object 150 is over the second threshold TH2 due to the influence of noise, the controller 350 according to the exemplary embodiment illustrated in FIG. 3 may determine the touch object 150 is in the touch state.

In order to overcome this type of error, the IR type touch screen system 300 illustrated in FIG. 9 further includes a pressure sensor 232 or 152 for further considering the pressure detection, thereby the hover state and the touch state can be more clearly distinguished.

Referring to FIG. 10, even though the blocking area of the IR ray beam by the touch object 150 is over the second threshold TH2 due to the influence of noise, the controller 350 according to the exemplary embodiment illustrated in FIG. 9 may determine the touch object 150 is in the hover state. In other words, if the touch object does not actually contact surface of the display panel 230, the the controller may determine the touch object 150 is in the hover state because the pressure is not detected by the pressure sensor 232 or 152.

Moreover, in determining the touch state, the controller 350 should consider the pressure detection as well as the obstructed portion by the touch object.

Therefore, referring to FIG. 10, when the blocking area of the IR ray beam by the touch object 150 is greater than the second threshold TH2 and the touch object 150 actually press the surface of the display panel 230, the controller 350 may determine the touch object 150 is in the touch state.

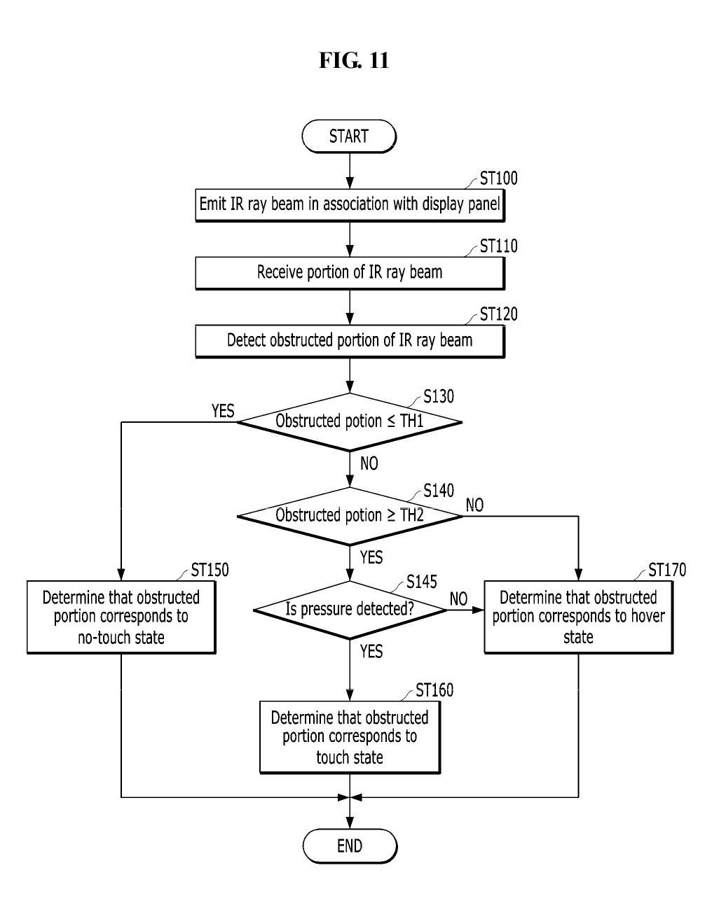

FIG. 11 is a flow chart illustrating a method of driving touch screen system according to one or more exemplary embodiments.

In this exemplary embodiment, steps identical to those of the aforementioned embodiment illustrated in FIG. 8 are designated by like reference numerals, and their detailed descriptions are not repeated to avoid redundancy and for easy description.

Referring to FIG. 11, The touch screen system according to one or more exemplary embodiments may further include a pressure sensor 232 in the display panel 230 or a pressure sensor 152 in the touch object 150 illustrated in FIG. 9. Therefore, with respect to the method of driving touch screen system illustrated in FIG. 9 may further include a step of determining whether the pressure by the touch object is detected or not (S 145).

To be specific, when the blocking area of the IR ray beam by the touch object 150 is greater than the second threshold TH2 (S 140), the controller 350 may further determine whether the touch object 150 actually presses the surface of the touch panel 230 or not (S 145). As already explained above, the pressure sensor 152 or 232 can detect that the touch object 150 contacts the surface of the display panel 230. When the touch object 150 actually contacts the surface of the display panel 230, the variance of the pressure can be detected by the pressure sensor 152 or 232. Then, the information with respect to the detection of the pressure may be transmitted to the controller 350 by communicating between the controller 350 and the pressure sensor 152 or 232. Thus, the controller 350 may determine whether the pressure by the touch object is detected or not (S 145).

Accordingly, even though the obstructed portion, the blocking area of the IR ray beam by the touch object 150, is over the second threshold TH2 (S 145), if the pressure by the touch object 150 is not detected, the controller 350 may determine the touch object 150 is in the hover state (ST 170).

Moreover, when the obstructed portion is greater than the second threshold TH2 (S 140) and the touch object 150 actually press the surface of the display panel 230 (S 145), the controller 350 may determine the touch object 150 is in the touch state (ST 160).

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A touch screen system, comprising:
a display;
a first optical emitter disposed in association with a first side of the display, the first optical emitter being configured to emit a first infrared (IR) ray beam in a first direction;
a first optical receiver disposed in association with a second side of the display, the first optical receiver being configured to receive the first IR ray beam; and
a controller configured to determine, in response to obstruction of the first IR ray beam by a portion of an object, an interactive state of the object with the display based on an amount of cross-sectional area of the first IR ray beam obstructed by the portion,
wherein a height of the first IR ray beam in a second direction is greater than a width of the first IR ray beam in a third direction.

2. The touch screen system of claim 1, further comprising:
a second optical emitter disposed in association with a third side of the display, the second optical emitter being configured to emit a second IR ray beam in the third direction; and
a second optical receiver disposed in association with a fourth side of the display, the second optical receiver being configured to receive the second IR ray beam,
wherein a height of the second IR ray beam in the second direction is greater than a width of the second IR ray beam in the first direction.

3. The touch screen system of claim 2, wherein:
the first optical emitter comprises first light emitting diodes (LEDs) configured to emit portions of the first IR ray beam, the first LEDs being spaced apart from one another in the second direction; and
the second optical emitter comprises second light emitting diodes (LEDs) configured to emit portions of the second IR ray beam, the second LEDs being spaced apart from one another in the second direction.

4. The touch screen system of claim 3, wherein:
the first optical receiver comprises first IR ray beam detectors configured to receive portions of the first IR ray beam, the first IR ray beam detectors being spaced apart from one another in the second direction; and
the second optical receiver comprises second IR ray beam detectors configured to receive portions of the second IR ray beam, the second IR ray beam detectors being spaced apart from one another in the second direction.

5. The touch screen system of claim 1, wherein a width of the portion of the object is greater than the width of the first IR ray beam.

6. The touch screen system of claim 1, wherein the height of the first IR ray beam is greater than 0 and less than three times the width of the first IR ray beam.

7. The touch screen system of claim 1, wherein, in response to the amount being less than or equal to a threshold amount, the controller is configured to determine the interactive state as a no-touch state of the object with the display.

8. The touch screen system of claim 1, wherein, in response to the amount being greater than a first threshold amount and less than a second threshold amount, the controller is configured to determine the interactive state as a hover state of the object over the display.

9. The touch screen system of claim 1, wherein:
the controller is configured to determine, in response to the amount being greater than a threshold amount, the interactive state as a touch state of the object with the display.

10. The touch screen system of claim 1, further comprises a pressure sensor configured to detect the pressure of the object contacting a surface of the display, and
wherein the controller is configured to receive the information related to the pressure detection.

11. The touch screen system of claim 10, wherein:
the controller is configured to determine, in response to receiving the information related to the pressure detection, the interactive state as a touch state of the object with the display.

12. A method for driving a touch screen system, the method comprising:
emitting, in association with a display, a first infrared (IR) ray in a first direction;
determining, in response to receiving a portion of the first IR ray, an amount of cross-sectional area of the first IR ray obstructed by an object; and
determining, based on the amount, an interactive state of the object with the display.

13. The method of claim 12, wherein a width of the first IR ray beam in a second direction is less than a height of the first IR ray beam in a third direction.

14. The method of claim 12, further comprising:
emitting, in association with the display, a second IR ray in a second direction crossing the first direction; and
determining, in response to receiving the portion of the first IR ray and a portion of the second IR ray, coordinates of the object.

15. The method of claim 12, wherein, in response to the amount being less than or equal to a threshold amount, the interactive state is determined as a no-touch state of the object with the display.

16. The method of claim 12, wherein, in response to the amount being greater than a first threshold amount and less than or equal to a second threshold amount, the interactive state is determined as a hover state of the object over the display.

17. The method of claim 12, wherein, in response to the amount being greater than or equal to a threshold amount, the interactive state is determined as a touch state of the object with the display.

18. The method of claim 12, further comprising:
detecting the pressure of the object contacting a surface of the display; and
determining, in response to receiving the information related to the pressure detection, coordinates of the object.

19. The method of claim 18, wherein, in response to the amount being greater than or equal to a threshold amount and in response to receiving information which indicates no pressure detection, the interactive state is determined as a hover state of the object over the display.

20. The method of claim 18, wherein, in response to the amount being greater than or equal to a threshold amount and in response to receiving the information related to the pressure detection, the interactive state is determined as a touch state of the object with the display.
